(19) United States
(12) Patent Application Publication
(10) Pub. No.: US 2010/0283899 A1
(43) Pub. Date: Nov. 11, 2010

(54) CONTOUR CORRECTION CIRCUIT

(76) Inventors: Koichi Inoue, Osaka (JP); Takaaki Iinuma, Kyoto (JP)

Correspondence Address: MCDERMOTT WILL & EMERY LLP, 600 13TH STREET, NW, WASHINGTON, DC, 20005-3096, US

(21) Appl. No.: 12/863,700

(22) PCT Filed: Dec. 8, 2008
(86) PCT No.: PCT/JP2008/003648

§ 371 Date: Jul. 20, 2010

(30) Foreign Application Priority Data
Mar. 12, 2008 (JP) 2008-062872

(51) Int. Cl. H04N 5/21

(52) U.S. Cl. 348/625; 348/E05.077

(57) ABSTRACT

A contour correction circuit according to the present invention determines, for a CVBS signal (a), a correction range of an edge of an image, and changes a contour component correction coefficient in a WINDOW in accordance with a state of a quality of the image, thereby solving a problem of overshoot caused at an edge of a video screen, performing optimum contour correction without excessive contour correction on a video image border part, and increasing the sharpness of the image.

### RELATED APPLICATIONS

This application is the U.S. National Phase under 35 U.S.C. §371 of International Application No. PCT/JP2008/003648, filed on Dec. 8, 2008, which in turn claims the benefit of Japanese Application No. 2008-062872, filed on Mar. 12, 2008, the disclosures of which Applications are incorporated by reference herein.

### TECHNICAL FIELD

The present invention relates to a contour correction circuit which corrects a contour component of a screen video signal of a television or the like and which increases the sharpness of an image.

### BACKGROUND ART

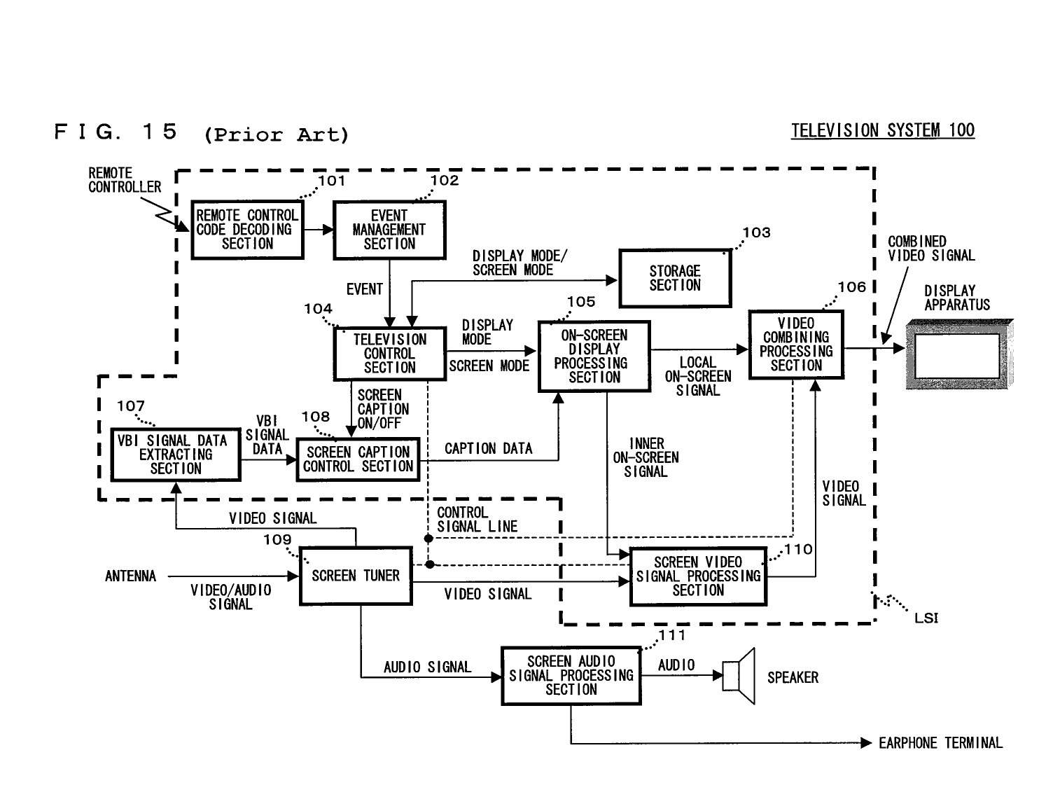

In recent years, improvement in image quality of a video of a television or the like has been required. Firstly, a system configuration which has been conventionally realized in a television will be described. FIG. 15 shows a television system 100 as an example of a configuration of a television system of conventional art. The television system 100 includes a remote control code decoding section 101, an event management section 102, a storage section 103, a television control section 104, an on-screen display processing section 105, a video combining processing section 106, a video blanking information (VBI) signal data extracting section 107, a screen caption control section 108, a screen tuner 109, a screen video signal processing section 110, and a screen audio signal processing section 111.

The screen tuner 109 receives video/audio signals from an antenna, outputs the audio signal to the screen audio signal processing section 111, and outputs the video signal to each of the VBI signal data extracting section 107 and the screen video signal processing section 110. The screen audio signal processing section 111 processes the audio signal from the screen tuner 109, and outputs an audio to a speaker. The VBI signal data extracting section 107 extracts VBI signal data from the video signal sent from the screen tuner 109, and outputs the VBI signal data to the screen caption control section 108. The screen caption control section 108 creates caption data, based on the VBI signal data extracted by the VBI signal data extracting section 107. Moreover, when a user of the television system 100 operates a remote controller, the remote control code decoding section 101 decodes a code transmitted from the remote controller. The event management section 102 determines an event sent from the remote control code decoding section 101, and gives an event instruction to the television control section 104. The television control section 104 controls a screen display or the like of the television system 100 in accordance with the instruction from the event management section 102. The television control section 104 notifies the screen caption control section 108 of ON/OFF of a screen caption, and thereby notification of caption data, which is given to the on-screen display processing section 105 by the screen caption control section 108, is controlled. The on-screen display processing section 105 performs conversion for the caption data sent from the screen caption control section 108, and for a display mode/screen mode sent from the television control section 104. Then, the on-screen display processing section 105 outputs an inner on-screen signal to the screen video signal processing section 110, and outputs a local on-screen signal to the video combining processing section 106. The screen video signal processing section 110 processes the video signal from the screen tuner 109, based on the inner on-screen signal from the on-screen display processing section 105. The video combining processing section 106 combines the video signal generated by the screen video signal processing section 110 with the local on-screen signal from the on-screen display processing section 105, and outputs the combined video signal to a display apparatus. Note that the television control section 104 and the storage section 103 exchange the current display mode and screen mode with each other.

In this manner, the display apparatus of the television system 100 displays a video signal from an antenna. In the television system 100, the screen video signal processing section 110 includes a contour correction circuit as disclosed in Patent Document 1, in order to sharpen a video image displayed by the display apparatus.

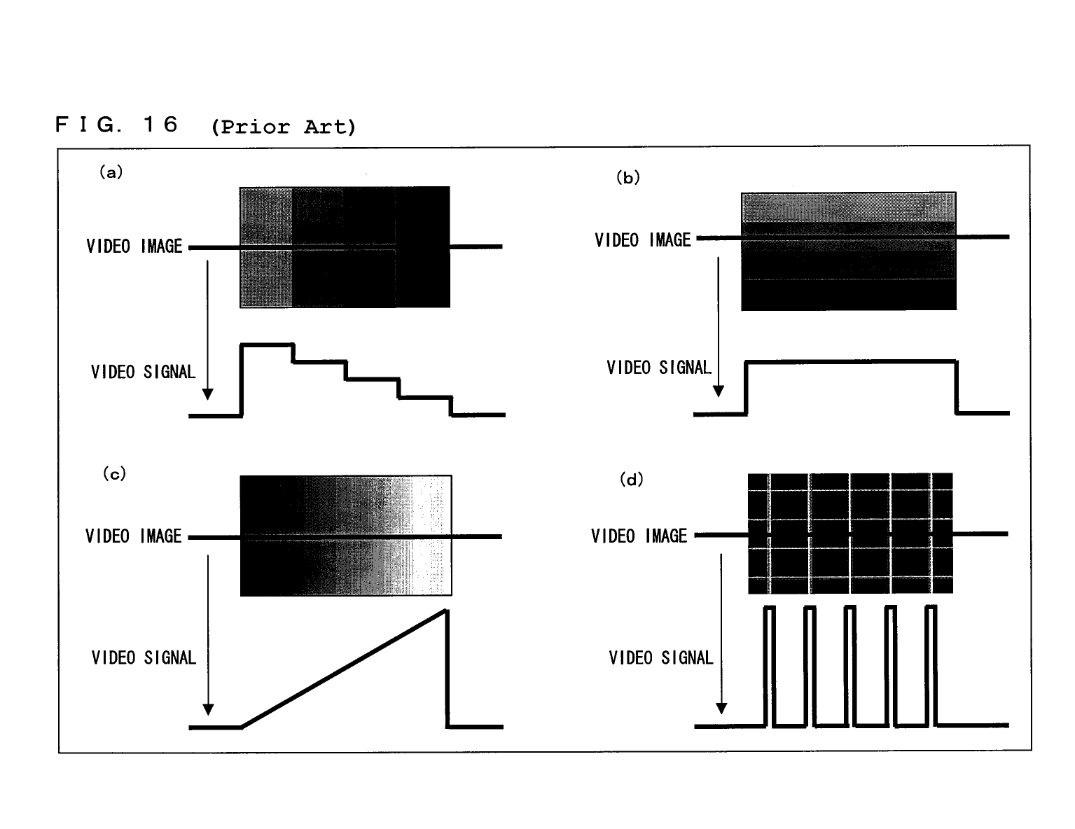

Note that FIG. 16 shows an example of the waveforms of video signals. The video signals in FIGS. 16(a) to (d) each correspond to one horizontal line of a video image. Hereinafter, in order to facilitate the understanding, a square wave (rectangular wave) shown in FIG. 16(b) will be described as an example.

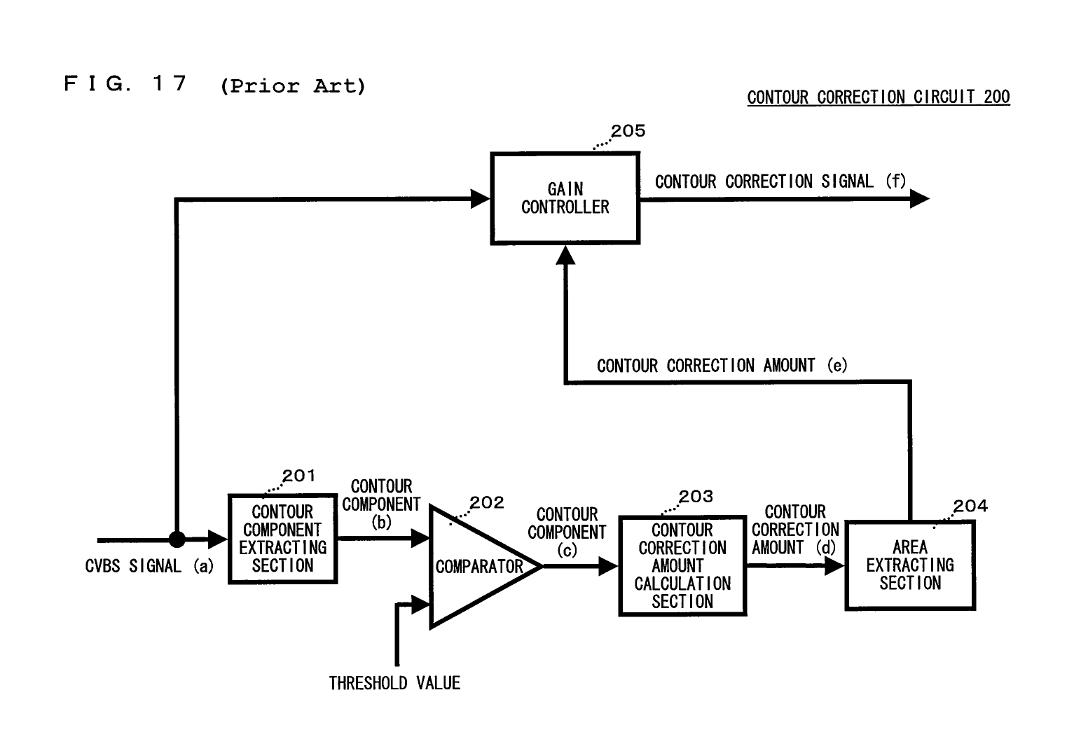

FIG. 17 shows a contour correction circuit 200 of conventional art. The contour correction circuit 200 includes a contour component extracting section 201, a comparator 202, a contour correction amount calculation section 203, an area extracting section 204, and a gain controller 205.

In the contour correction circuit 200, when a CVBS (Composite Video Base-band Signaling) signal (a) is inputted, the contour component extracting section 201 extracts a contour component (b) of an image from the CVBS signal (a), and outputs the contour component (b) to the comparator 202. The comparator 202 compares, with a threshold value, the amplitude of the contour component (b) extracted by the contour component extracting section 201. The contour correction amount calculation section 203 adjusts the amplitude of a contour component (c) which is the result of the comparison outputted from the comparator 202, and calculates a contour correction amount (d). The area extracting section 204 extracts, as a contour correction amount (e), a video image area for which a certain contour correction is to be performed, from the contour correction amount (d) calculated by the contour correction amount calculation section 203. The gain controller 205 combines the CVBS signal (a) with the contour correction amount (e) obtained by the area extracting section 204, and outputs a contour correction signal (f) which has been subjected to contour correction.

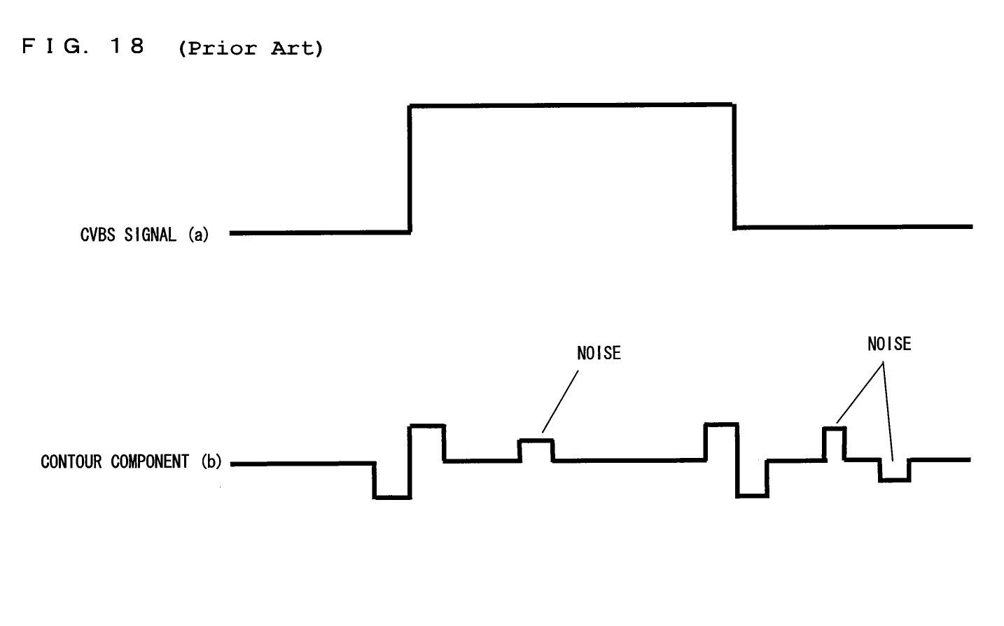

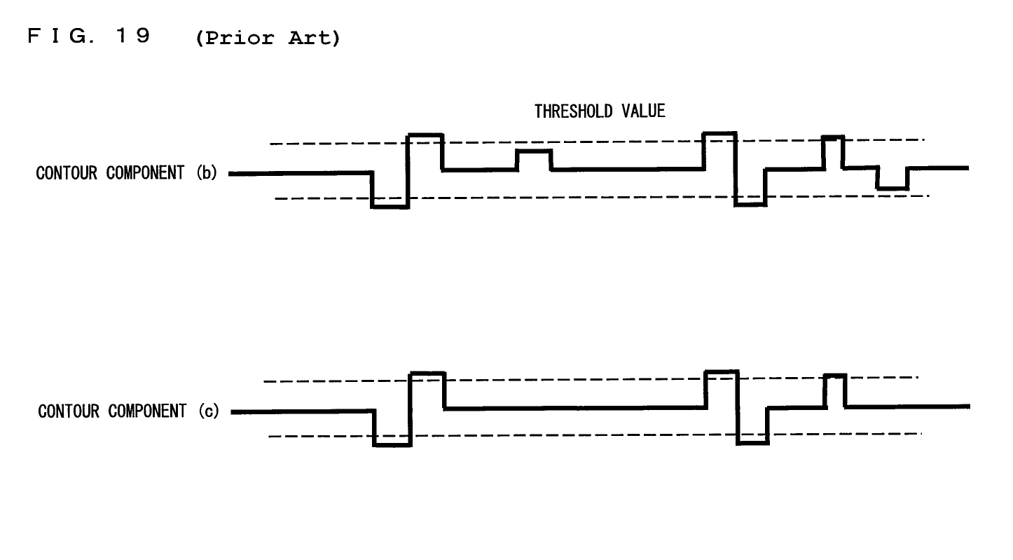

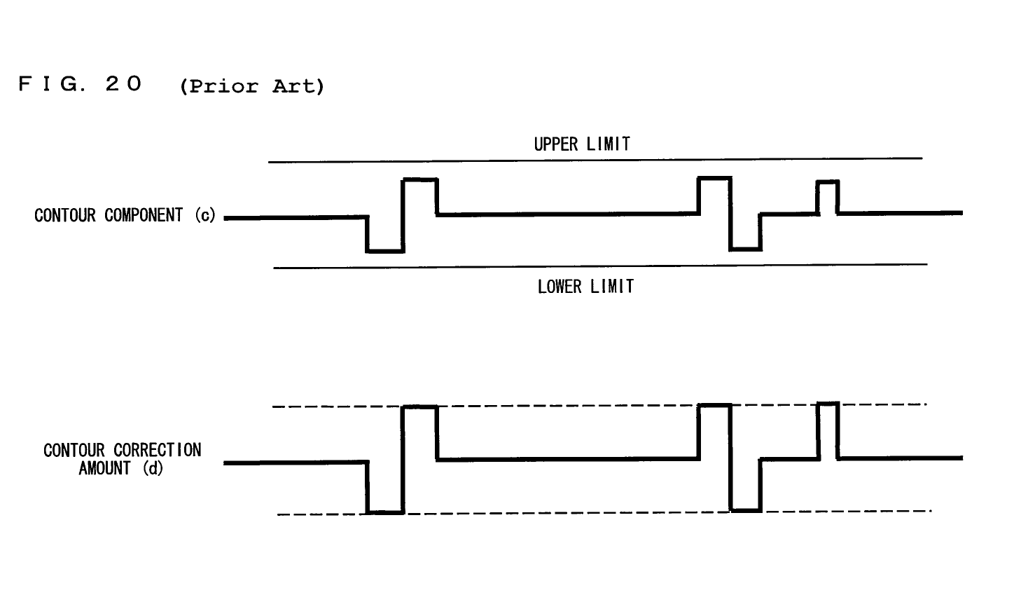

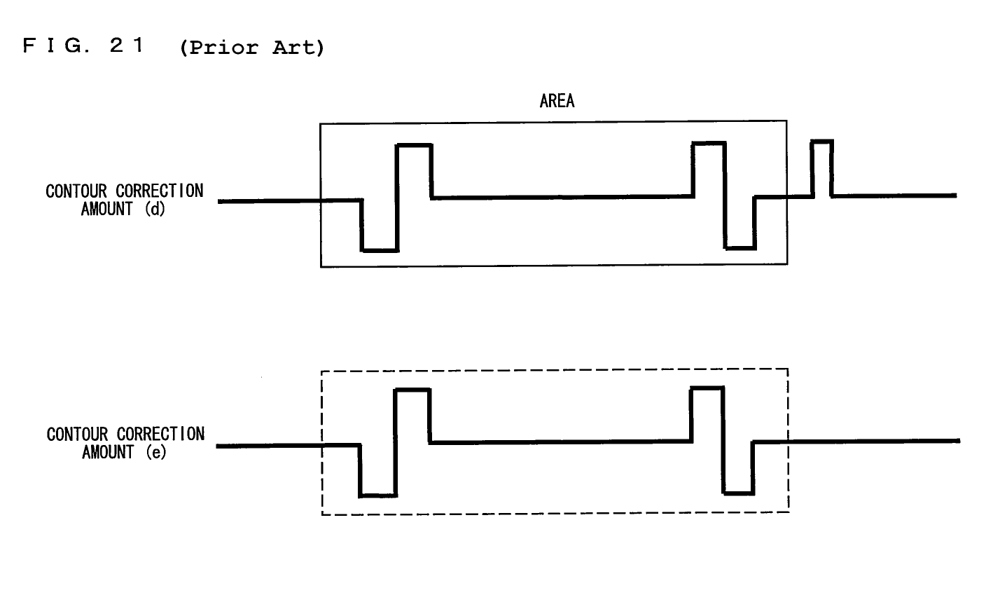

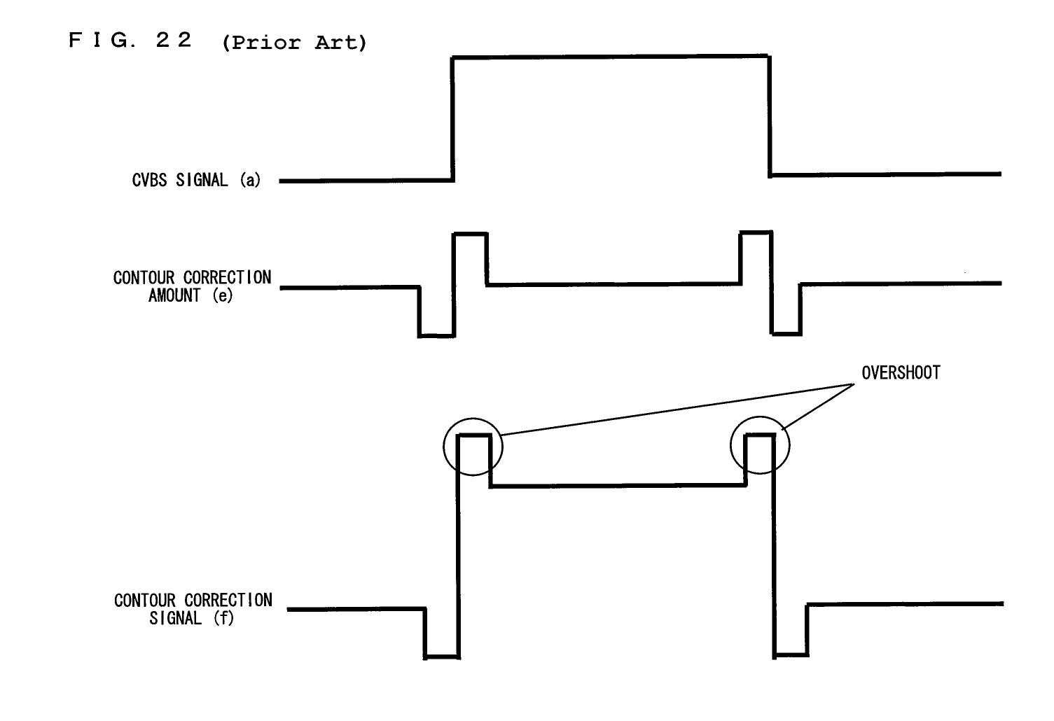

Extraction of the contour component (b) from the CVBS signal (a) and generation of the contour correction signal (f) will be specifically described. FIG. 18 shows the contour component extracting section 201 extracting the contour component (b) from the inputted CVBS signal (a). Even though the CVBS signal (a) appears flat, the CVBS signal (a) may actually include a slight noise. Therefore, in this case, a signal of the extracted contour component (b) includes, in addition to an original contour component, a high frequency noise at a flat part of an image. FIG. 19 shows the comparator 202 deleting a contour component whose amplitude does not exceed a threshold value. The comparator 202 compares, with a threshold value, the amplitude of the contour component (b) extracted by the contour component extracting section 201, and outputs, as a contour component (c), only a contour component whose amplitude exceeds a threshold value. This ensures that a contour correction amount described later is not added to a noise included in a part, of the CVBS signal (a), which is originally flat. FIG. 20 shows the contour correction amount calculation section 203 amplifying the amplitude of the contour component (c). The contour correction amount calculation section 203 amplifies the amplitude of the contour component (c) outputted by the comparator 202, adjusts upper and lower limits of the amplitude of the contour component, and generates a contour correction amount (d). FIG. 21 shows the area extracting section 204 extracting, from the contour correction amount (d), a contour correction amount (e) in an area for which a certain contour correction is to be performed. The area extracting section 204 deletes, from the contour correction amount (d) outputted by the contour correction amount calculation section 203, a contour correction amount in an area other than the area for which the certain contour correction is to be performed, and extracts the contour correction amount (e) in the area for which the certain contour correction is to be performed. FIG. 22 shows the gain controller 205 combining the CVBS signal (a) with the contour correction amount (e). The gain controller 205 combines the CVBS signal (a) with the contour correction amount (e), and thereby generates a contour correction signal (f) which has been subjected to contour correction.

Thus, the contour correction circuit 200 of conventional art extracts the contour component (b) from the CVBS signal (a), combines the CVBS signal (a) with the contour correction amount (e) in an area for which a certain contour correction is to be performed, and generates the contour correction signal (f). Therefore, the contour correction circuit 200 of conventional art makes it possible to prevent the quality of an image at a part other than a contour part from being deteriorated due to increase in noise or the like, and at the same time, to increase the sharpness of an image in the area for which the certain contour correction is to be performed, by correcting a contour component of the image.

Patent Document 1: Japanese Laid-Open Patent Publication No. H04-175071

### DISCLOSURE OF THE INVENTION

### Problems to be Solved by the Invention

However, the contour correction circuit 200 of conventional art has a problem that overshoot appears at an edge of a video image or a screen due to excessive contour correction being performed in order to increase the sharpness of the image at a contour part. As shown in FIG. 22, overshoot in which a waveform exceeds a baseline indicating a steady-state value is caused at a part, of the contour correction signal (f), at which a video signal wave rises. As a result, the quality of the image is decreased.

Therefore, an object of the present invention is to provide a contour correction circuit which solves a problem of overshoot caused due to contour correction processing performed by the contour correction circuit 200 of conventional art, performs optimum contour correction without excessive contour correction on a video image border part, and increases the sharpness of the image.

### Solution to the Problems

To achieve the above object, a first contour correction circuit of the present invention which corrects a contour component of a screen video signal includes: a contour component extracting section for extracting the contour component from the screen video signal; a comparator for comparing an amplitude of the contour component with a threshold value; a contour correction amount calculation section for, based on a result of the comparison, adjusting the amplitude of the contour component and calculating a contour correction amount; an area extracting section for extracting, from the contour correction amount, a contour correction amount in a video image area for which a certain contour correction is to be performed; a contour component correction range determining section for determining, as a correction range of the contour component of the screen video signal, a video image edge area which is an upper, lower, right, or left edge of the video image area; a contour component linear limiter correction processing section for correcting the contour correction amount extracted by the area extracting section, by performing linear limiter processing which connects, by a straight line, amplitude values of a start point and an end point of the video image edge area which is the upper, lower, right, or left edge and is the correction range; and a gain controller for combining the screen video signal with a contour correction amount generated by the contour component linear limiter correction processing section.

To achieve the above object, a second contour correction circuit of the present invention which corrects a contour component of a screen video signal includes: a contour component extracting section for extracting the contour component from the screen video signal; a comparator for comparing an amplitude of the contour component with a threshold value; a contour correction amount calculation section for, based on a result of the comparison, adjusting the amplitude of the contour component and calculating a contour correction amount; an area extracting section for extracting, from the contour correction amount, a contour correction amount in a video image area for which a certain contour correction is to be performed; a contour component correction range determining section for determining, as a correction range of the contour component of the screen video signal, a video image edge area which is an upper, lower, right, or left edge of the video image area; a contour component γ-curve limiter correction processing section for correcting the contour correction amount extracted by the area extracting section, by performing γ-curve limiter processing which connects, by a γ-curve, amplitude values of a start point and an end point of the video image edge area which is the upper, lower, right, or left edge and is the correction range; and a gain controller for combining the screen video signal with a contour correction amount generated by the contour component γ-curve limiter correction processing section.

To achieve the above object, a third contour correction circuit of the present invention which corrects a contour component of a screen video signal includes: a contour component extracting section for extracting the contour component from the screen video signal; a comparator for comparing an amplitude of the contour component with a threshold value; a contour correction amount calculation section for, based on a result of the comparison, adjusting the amplitude of the contour component and calculating a contour correction amount; an area extracting section for extracting, from the contour correction amount, a contour correction amount in a video image area for which a certain contour correction is to be performed; a contour component correction range determining section for determining, as a correction range of the contour component of the screen video signal, a video image edge area which is an upper, lower, right, or left edge of the video image area; a contour component average limiter correction processing section for correcting the contour correction amount extracted by the area extracting section, by using an average limiter which averages amplitude values of the video image edge area which is the upper, lower, right, or left edge and is the correction range; and a gain controller for combining the screen video signal with a contour correction amount generated by the contour component average limiter correction processing section.

To achieve the above object, a broadcast reception apparatus of the present invention which demodulates a video signal and an audio signal included in a television signal and outputs a video and an audio, includes: a television signal reception section for receiving the television signal via a broadcast path; a video signal processing section for demodulating the video signal; an audio signal processing section for demodulating the audio signal; an instruction input section for receiving an instruction from an operator; and an event management section for determining processing to be executed, based on a current state and an input from the instruction input section. The video signal processing section includes any one of the above-described first to third contour correction circuits of the present invention.

### EFFECT OF THE INVENTION

As described above, a contour correction circuit of the present invention makes it possible to provide a contour correction circuit which solves a problem of overshoot caused at an edge of a video screen, performs optimum contour correction without excessive contour correction on a video image border part, and increases the sharpness of the image.

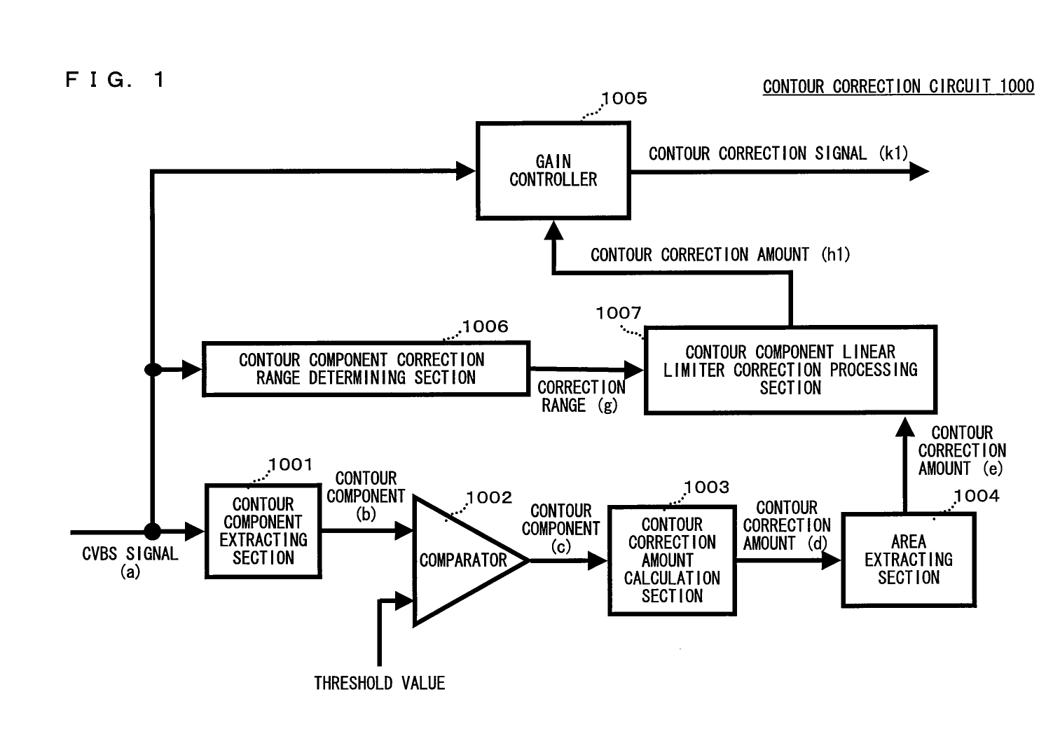

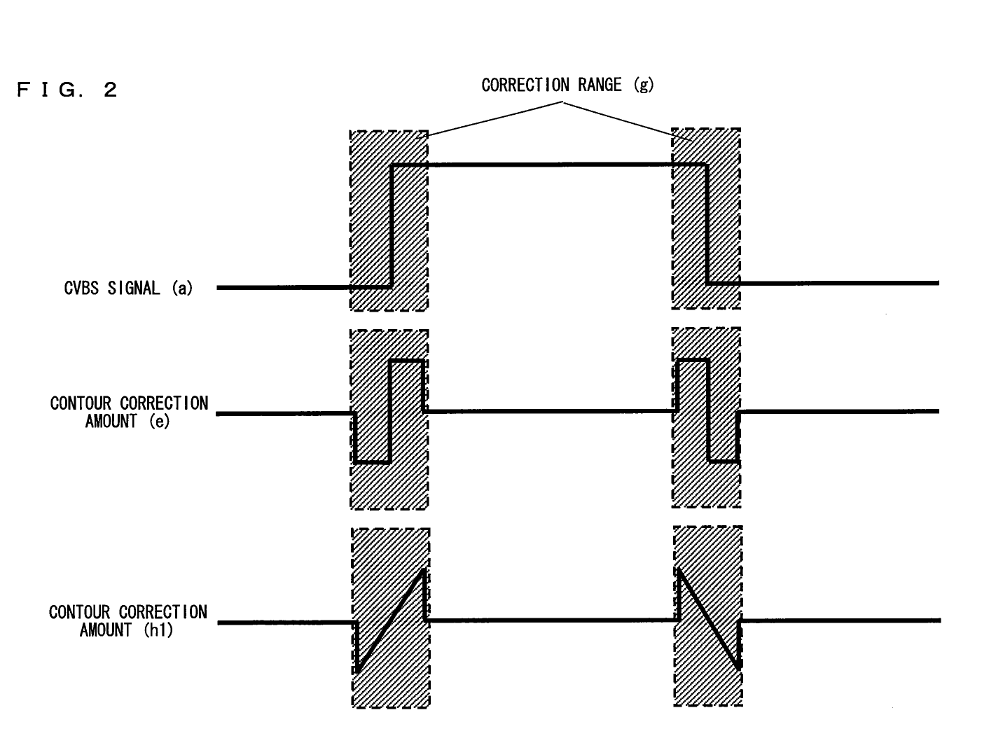

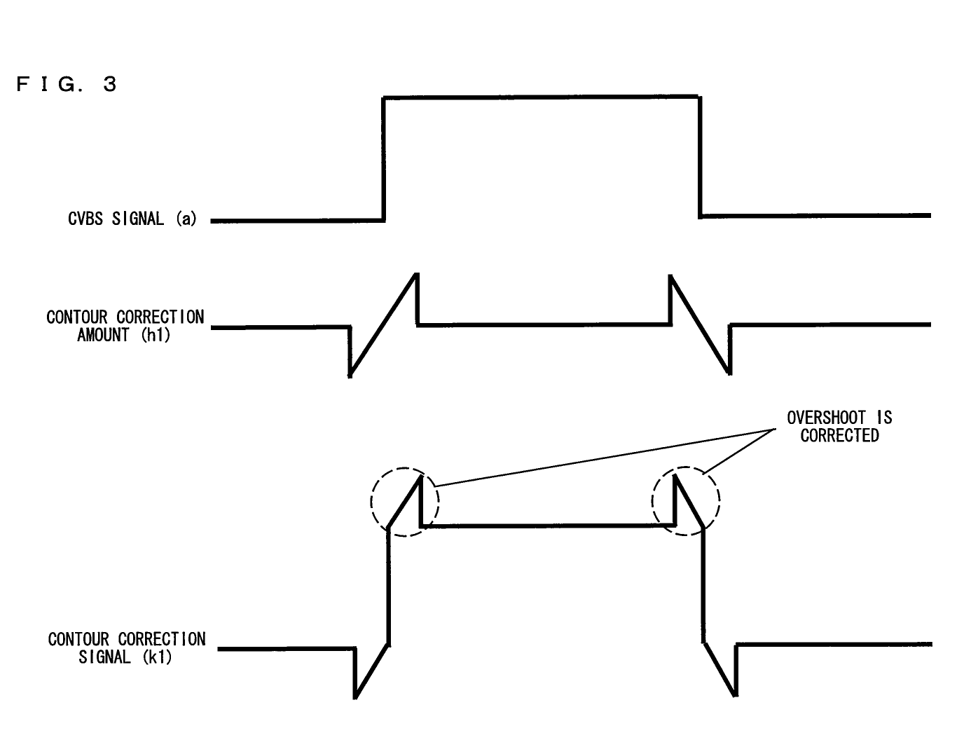

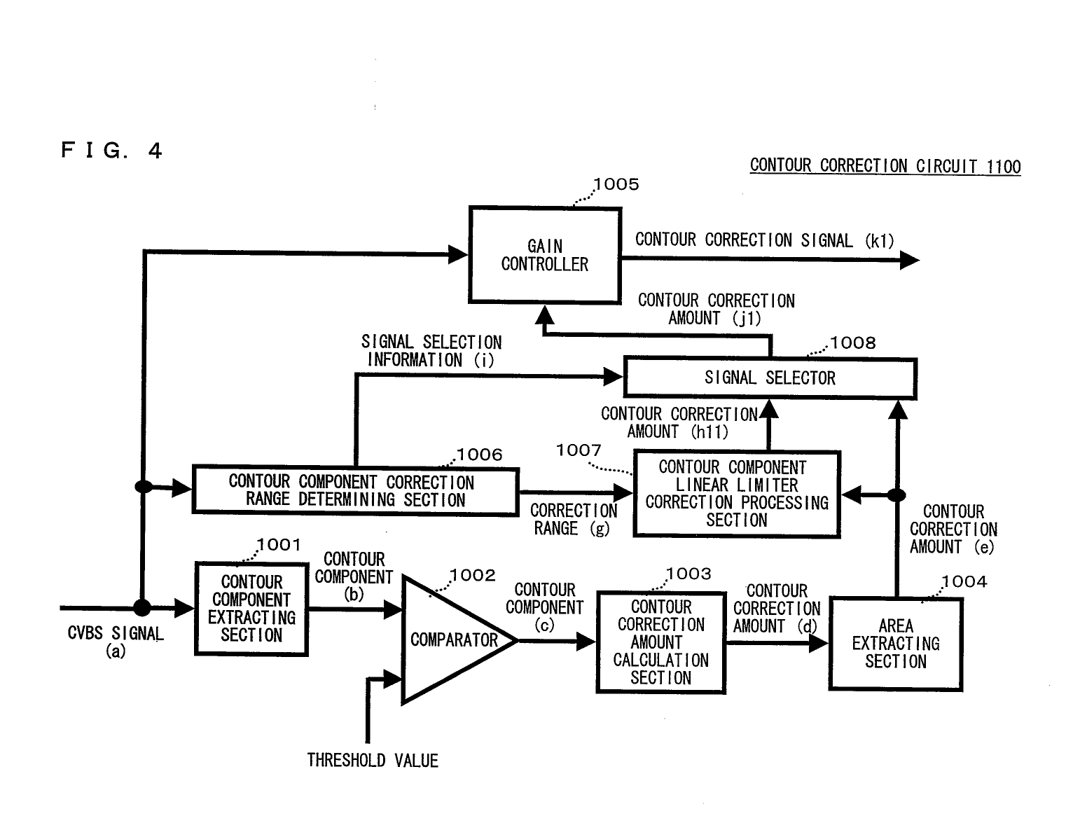

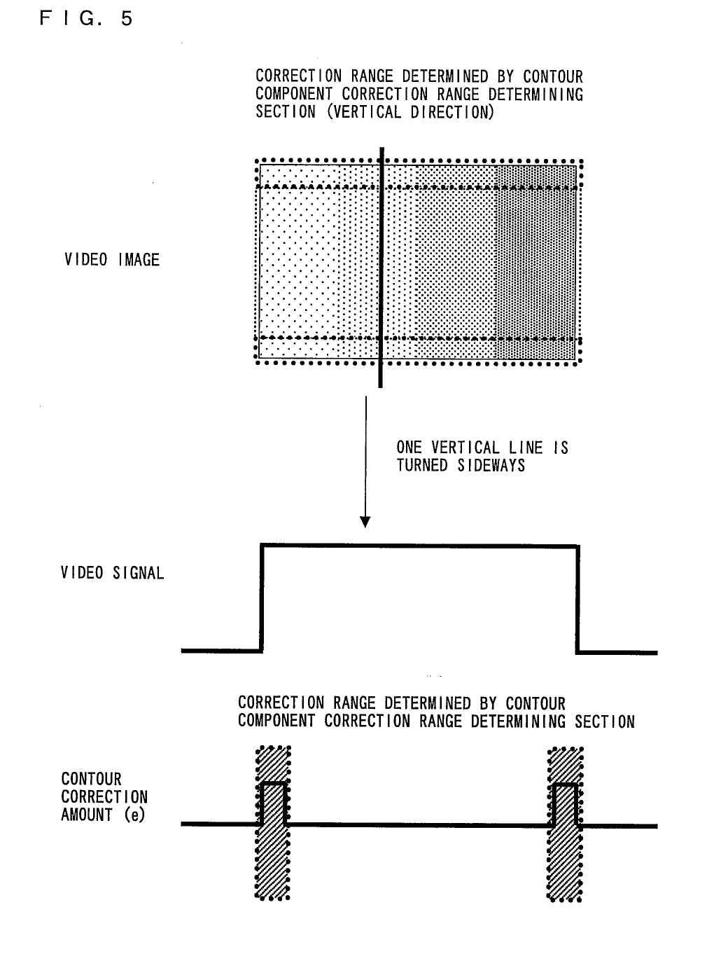

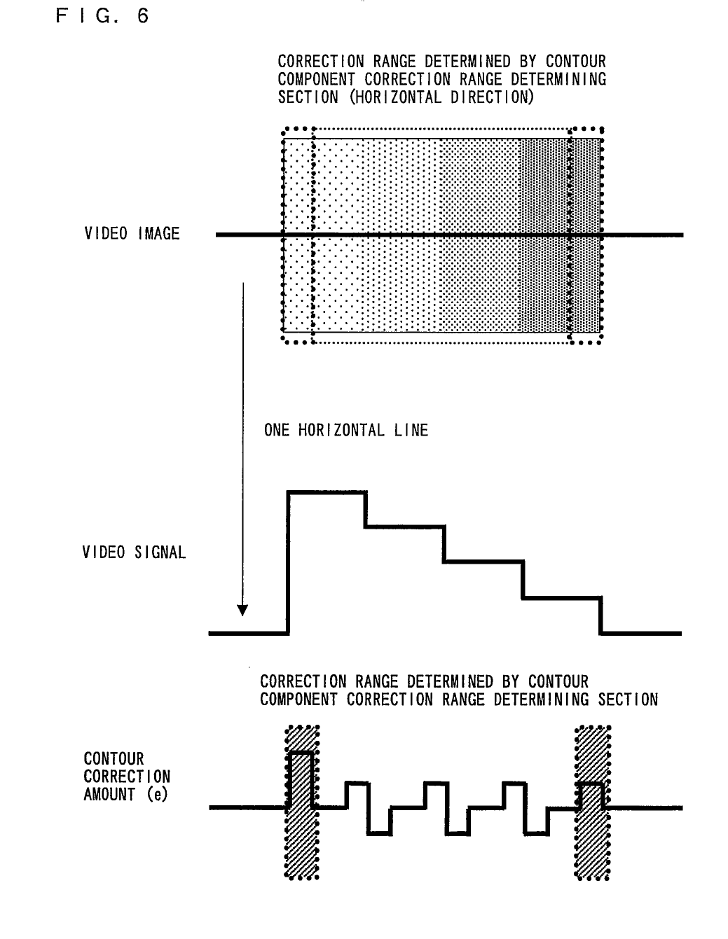

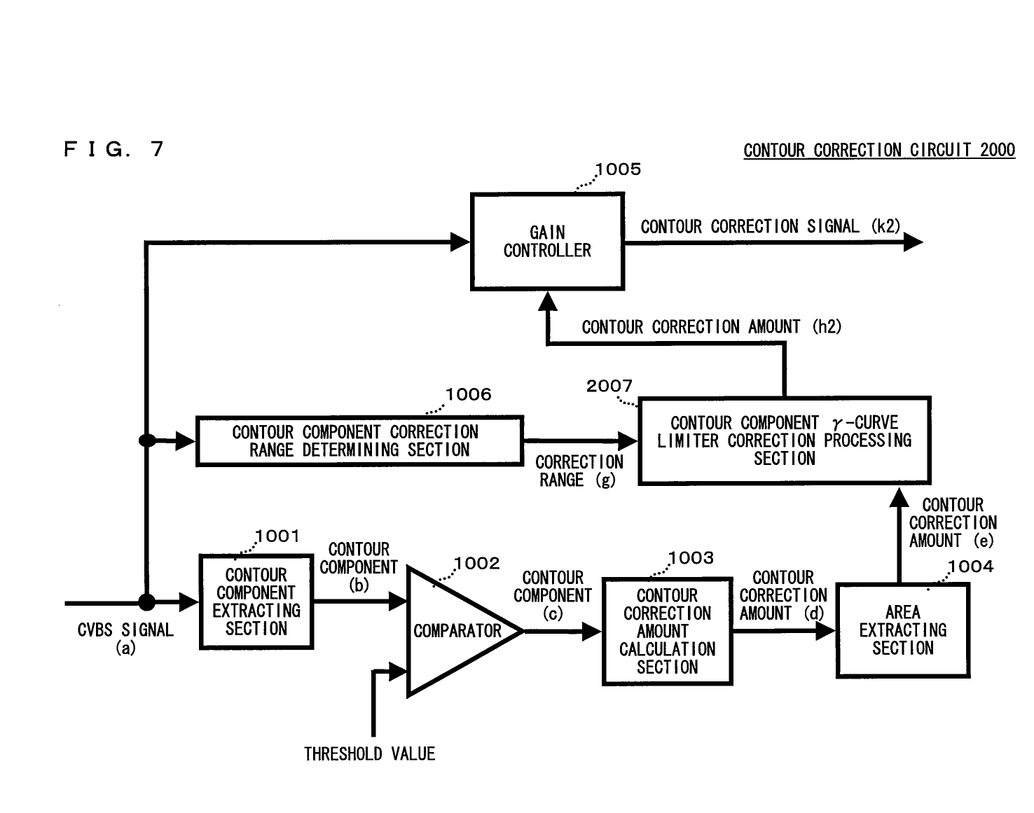

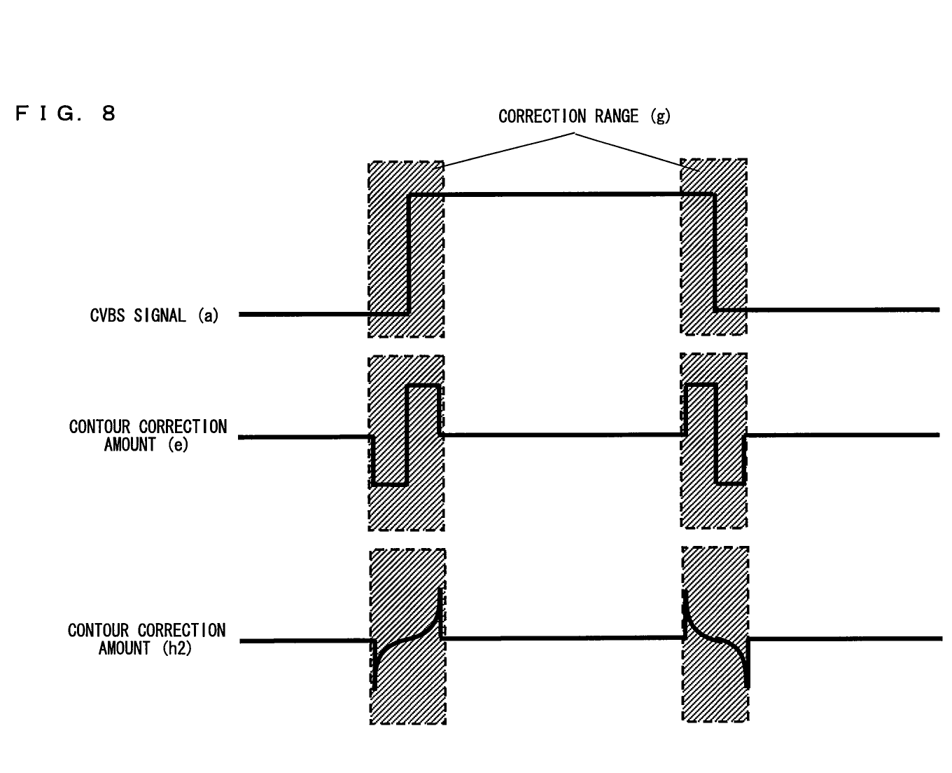

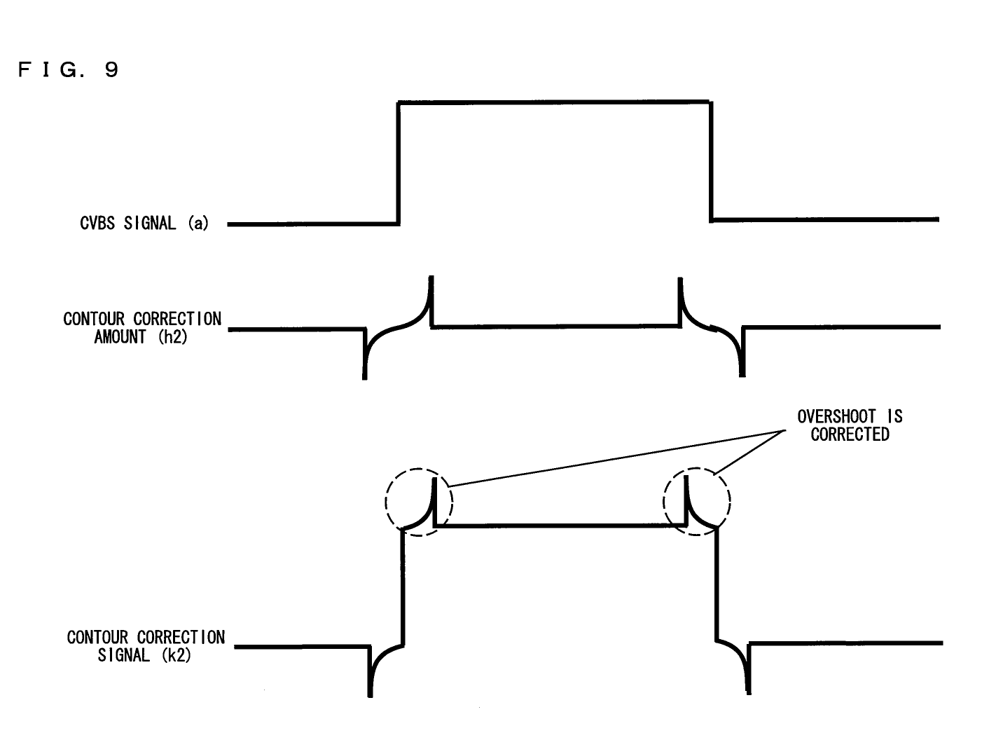

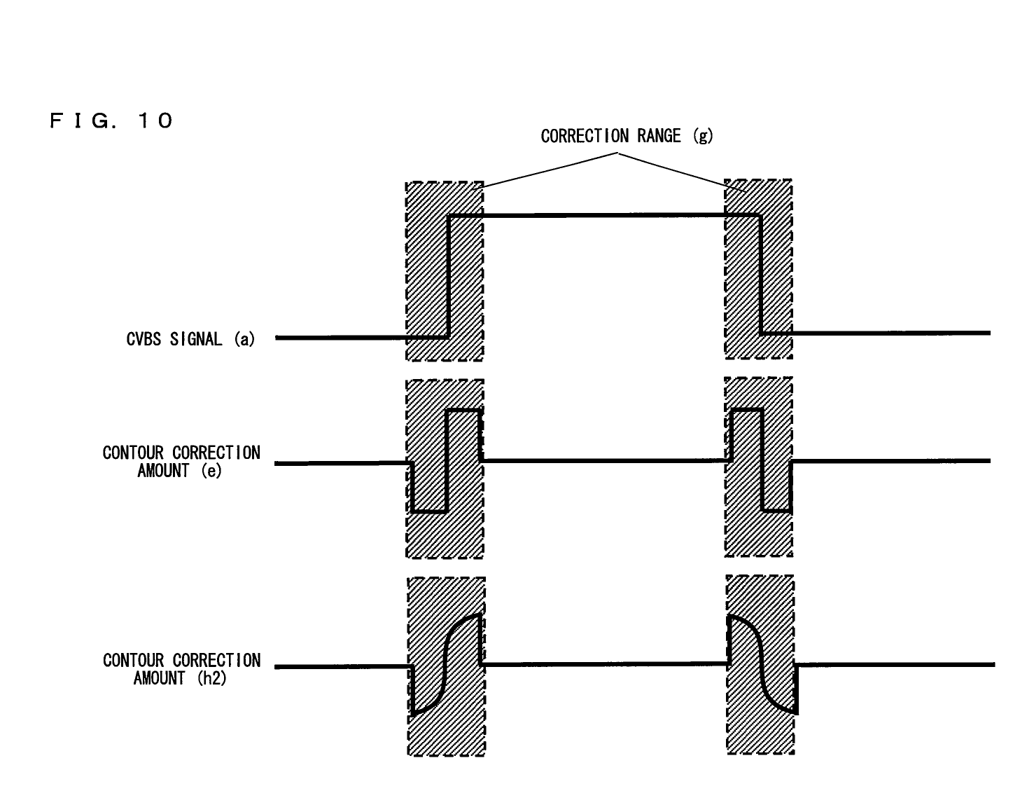

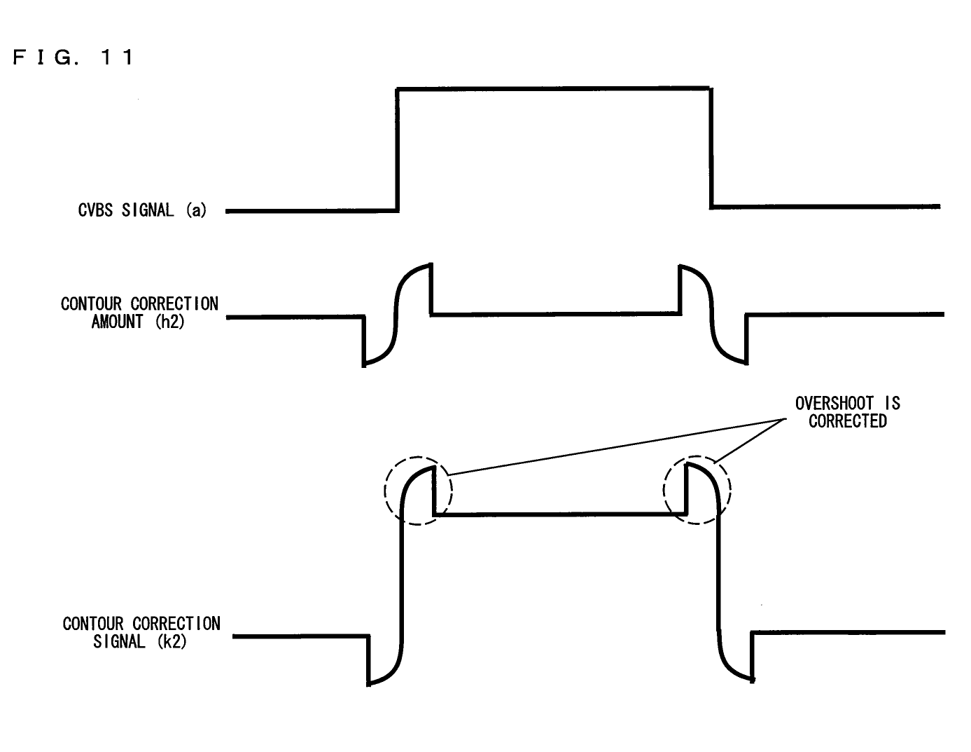

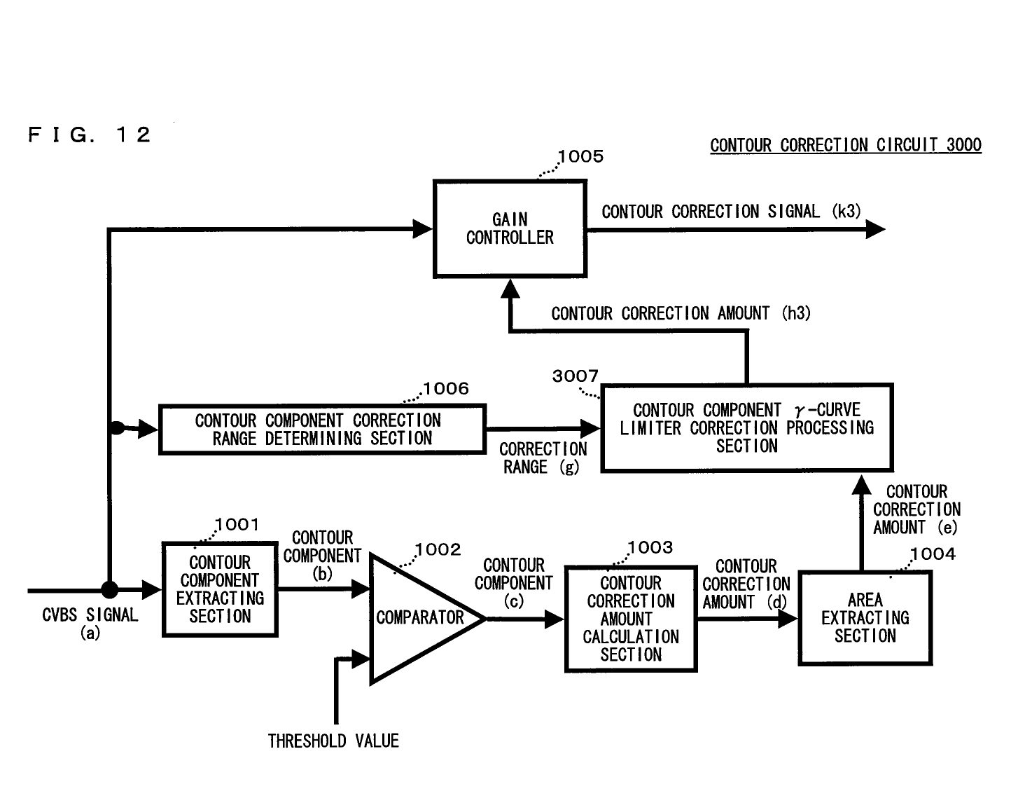

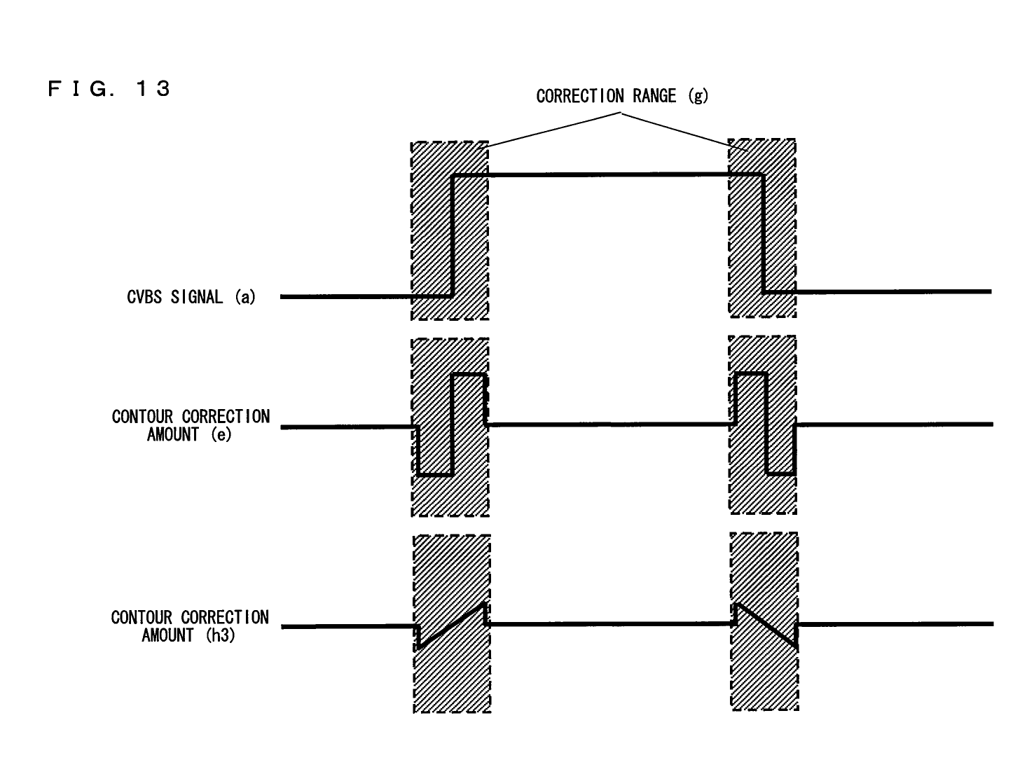

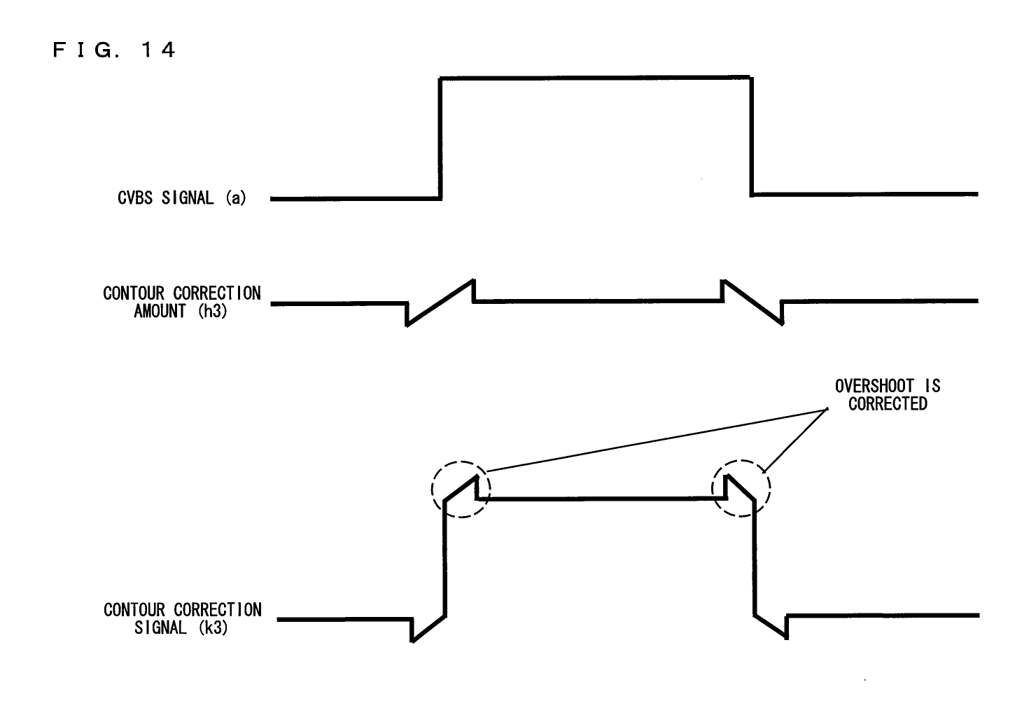

### BRIEF DESCRIPTION OF THE DRAWINGS

[FIG. 1] FIG. 1 shows a contour correction circuit 1000 according to a first embodiment of the present invention.

[FIG. 2] FIG. 2 shows processing performed by a contour component linear limiter correction processing section 1007.

[FIG. 3] FIG. 3 shows a contour correction signal (k1) obtained through contour correction performed by the contour correction circuit 1000 according to the first embodiment of the present invention.

[FIG. 4] FIG. 4 shows a contour correction circuit 1100 according to the first embodiment of the present invention.

[FIG. 5] FIG. 5 shows a square wave (rectangular wave) corresponding to one vertical line of a video image.

[FIG. 6] FIG. 6 shows a contour correction range for a video signal shown in FIG. 16(a).

[FIG. 7] FIG. 7 shows a contour correction circuit 2000 according to a second embodiment of the present invention.

[FIG. 8] FIG. 8 shows processing performed by a contour component γ-curve limiter correction processing section 2007.

[FIG. 9] FIG. 9 shows a contour correction signal (k2) obtained through contour correction performed by the contour correction circuit 2000 according to the second embodiment of the present invention.

[FIG. 10] FIG. 10 shows processing performed by a contour component γ-curve limiter correction processing section 2007.

[FIG. 11] FIG. 11 shows the contour correction signal (k2) obtained through contour correction performed by the contour correction circuit 2000 according to the second embodiment of the present invention.

[FIG. 12] FIG. 12 shows a contour correction circuit 3000 according to a third embodiment of the present invention.

[FIG. 13] FIG. 13 shows processing performed by a contour component average limiter correction processing section 3007.

[FIG. 14] FIG. 14 shows a contour correction signal (k3) obtained through contour correction performed by the contour correction circuit 3000 according to the third embodiment of the present invention.

[FIG. 15] FIG. 15 shows an example of a configuration of a television system of conventional art.

[FIG. 16] FIG. 16 shows an example of a video signal waveform.

[FIG. 17] FIG. 17 shows a contour correction circuit 200 of conventional art.

[FIG. 18] FIG. 18 shows a contour component extracting section 201 extracting a contour component from an inputted CVBS signal.

[FIG. 19] FIG. 19 shows a comparator 202 deleting a contour component whose amplitude does not exceed a threshold value.

[FIG. 20] FIG. 20 shows a contour correction amount calculation section 203 amplifying the amplitude of a contour component.

[FIG. 21] FIG. 21 shows an area extracting section 204 extracting a contour component in an area for which contour correction is to be performed.

[FIG. 22] FIG. 22 shows a contour correction signal obtained through contour correction performed by the contour correction circuit 200 of conventional art.

### DESCRIPTION OF THE REFERENCE CHARACTERS

100 television system
101 remote control code decoding section
102 event management section
103 storage section
104 television control section
105 on-screen display processing section
106 video combining processing section
107 VBI signal data extracting section
108 screen caption control section
109 screen tuner
110 screen video signal processing section
111 screen audio signal processing section
200, 1000, 1100, 2000, 3000 contour correction circuit
201, 1001 contour component extracting section
202, 1002 comparator
203, 1003 contour correction amount calculation section
204, 1004 area extracting section
205, 1005 gain controller
1006 contour component correction range determining section
1007 contour component linear limiter correction processing section
1008 signal selector
2007 contour component γ-curve limiter correction processing section
3007 contour component average limiter correction processing section

### BEST MODE FOR CARRYING OUT THE INVENTION

Hereinafter, embodiments of the present invention will be described referring to the drawings.

### First Embodiment

FIG. 1 shows a contour correction circuit 1000 according to a first embodiment of the present invention. The contour correction circuit 1000 includes a contour component extracting section 1001, a comparator 1002, a contour correction amount calculation section 1003, an area extracting section 1004, a gain controller 1005, a contour component correction range determining section 1006, and a contour component linear limiter correction processing section 1007.

In the contour correction circuit 1000, when a CVBS signal (a) is inputted, the contour component extracting section 1001 extracts a contour component (b) of an image from the CVBS signal (a), and outputs the contour component (b) to the comparator 1002. The comparator 1002 compares, with a threshold value, the amplitude of the contour component (b) extracted by the contour component extracting section 1001. The contour correction amount calculation section 1003 adjusts the amplitude of a contour component (c) which is the result of the comparison outputted from the comparator 1002, and calculates a contour correction amount (d). The area extracting section 1004 extracts, as a contour correction amount (e), a video image area for which a certain contour correction is to be performed, from the contour correction amount (d) calculated by the contour correction amount calculation section 1003. The operation described thus far is the same as that performed by the contour component extracting section 201, the comparator 202, the contour correction amount calculation section 203, and the area extracting section 204 in the contour correction circuit 200 which is described in BACKGROUND ART. A process from extraction of the contour component (b) to generation of the contour correction amount (e) is the same as that described in BACKGROUND ART referring to FIG. 18 to FIG. 21, and therefore, the detailed description thereof is omitted here. Hereinafter, the difference between the contour correction circuit 1000 according to the first embodiment of the present invention and the contour correction circuit 200 of conventional art will be described in detail.

The contour correction circuit 1000 according to the first embodiment of the present invention further includes a contour component correction range determining section 1006 and a contour component linear limiter correction processing section 1007, in addition to the contour correction circuit 200 of conventional art. The contour component correction range determining section 1006 determines, for the CVBS signal (a), a correction range of a contour component of an image. The correction range (g) determined by the contour component correction range determining section 1006 is a video image edge area which is an upper, lower, right, or left edge of a video image area, and the contour component linear limiter correction processing section 1007 is notified of the correction range (g). The contour component linear limiter correction processing section 1007 corrects, in the correction range (g), the contour correction amount (e) generated by the area extracting section 1004. FIG. 2 shows processing performed by the contour component linear limiter correction processing section 1007. A shaded area in FIG. 2 is the correction range (g) determined by the contour component correction range determining section 1006. The contour component linear limiter correction processing section 1007 corrects, in the correction range (g), the contour correction amount (e) generated by the area extracting section 1004, by using a linear limiter for replacing the contour correction amount (e) by a straight line, and thereby generates a contour correction amount (h1). Moreover, the contour component linear limiter correction processing section 1007 outputs the contour correction amount (h1) to the gain controller 1005.

FIG. 3 shows the gain controller 1005 combining the CVBS signal (a) with the contour correction amount (h1). The gain controller 1005 combines the CVBS signal (a) with the contour correction amount (h1), and thereby generates the contour correction signal (k 1) which has been subjected to contour correction.

Thus, the contour correction circuit 1000 according to the first embodiment of the present invention extracts the contour component (b) from the CVBS signal (a), and generates the contour correction amount (e) in the same manner as in the contour correction circuit 200 of conventional art. Further, the contour correction circuit 1000 according to the first embodiment of the present invention combines the CVBS signal (a) with the contour correction amount (h1) generated by the contour component linear limiter correction processing section 1007, and thereby generates the contour correction signal (k1). That is, the contour correction circuit 1000 according to the first embodiment of the present invention determines, for the CVBS signal (a), a correction range of an edge of an image, and changes a contour component correction coefficient in a WINDOW in accordance with the state of the image quality, thereby performing an optimum contour correction.

Note that although the description thus far is based on the assumption that contour correction processing is performed for a square wave (rectangular wave) corresponding to one horizontal line of the video image shown in FIG. 16 (b), the same contour correction processing is performed also for a vertical direction of the video image. FIG. 5 shows a square wave (rectangular wave) corresponding to one vertical line of the video image. Referring to FIG. 5, the contour correction circuit 1000 determines, for a square wave (rectangular wave) corresponding to the one vertical line of the video image shown in FIG. 5, a correction range of a contour component of an image, by using the contour component correction range determining section 1006, and performs the same contour correction processing also for the vertical direction of the video image.

As described above, the contour correction circuit 1000 according to the first embodiment of the present invention can solve a problem of overshoot caused at an edge of a video screen, perform optimum contour correction without excessive contour correction on a video image border part, and increase the sharpness of the image.

Note that although in the present embodiment, entire processing of generating the contour correction amount (h1) which is to be combined with the CVBS signal (a) is performed by the contour component linear limiter correction processing section 1007, the processing may be divided into several parts. For example, it is conceivable that a signal selector is provided. FIG. 4 shows a contour correction circuit 1100 according to the first embodiment of the present invention. The contour correction circuit 1100 is configured to further include a signal selector 1008, in addition to the contour correction circuit 1000 shown in FIG. 1. The contour component correction range determining section 1006 notifies the signal selector 1008 of signal selection information (i). The signal selection information (i) is information for giving notification of signals to be selected respectively for the inside and the outside of the correction range (g) determined by the contour component correction range determining section 1006. Based on the signal selection information (i) from the contour component correction range determining section 1006, the signal selector 1008 selects the contour correction amount (e) for the outside of the correction range (g), selects a contour correction amount (h11) for the inside of the correction range (g), and outputs the selected contour correction amount as a contour correction amount (j1) to the gain controller 1005. In this case, the contour component linear limiter correction processing section 1007 operates only for the inside of the correction range (g), and outputs the contour correction amount (h11) to the signal selector 1008. Thus, the contour correction circuit 1100 according to the first embodiment of the present invention combines the CVBS signal (a) with the contour correction amount (j1) from the signal selector 1008, and generates the contour correction signal (k1). Therefore, even with the configuration of the contour correction circuit 1100, the same effect as that obtained by the contour correction circuit 1000 can be obtained.

Note that although in the present embodiment, an example where the contour correction processing is performed for a square wave (rectangular wave) is described in order to facilitate the understanding, it is understood that the contour correction processing can be performed for other video signals in the same manner. For example, in the case of processing a video signal shown in FIG. 16 (a), the contour correction circuit 1000 determines, for the video signal shown in FIG. 16 (a), a correction range of the contour component of an image, by using the contour component correction range determining section 1006, and performs the contour correction processing for the video signal shown in FIG. 16 (a). FIG. 6 shows a contour correction range for the video signal shown in FIG. 16 (a). As shown in FIG. 6, the contour correction circuit 1000 determines a correction range of the contour component by using the contour component correction range determining section 1006, and thereby can solve a problem of overshoot caused at an edge of the video screen and increase the sharpness of an image.

### Second Embodiment

FIG. 7 shows a contour correction circuit 2000 according to a second embodiment of the present invention. The contour correction circuit 2000 includes a contour component γ-curve limiter correction processing section 2007 in place of the contour component linear limiter correction processing section 1007 of the contour correction circuit 1000 according to the first embodiment of the present invention. In FIG. 7, the same components as those of the contour correction circuit 1000 shown in FIG. 1 are denoted by the same reference numerals, and the description thereof is omitted.

FIG. 8 shows processing performed by the contour component γ-curve limiter correction processing section 2007. A shaded part in FIG. 8 is the correction range (g) determined by the contour component correction range determining section 1006. The contour component γ-curve limiter correction processing section 2007 corrects, in the correction range (g), the contour correction amount (e) generated by the area extracting section 1004, by using a γ-curve limiter for replacing the contour correction amount (e) by a γ-curve, and thereby generates a contour correction amount (h2). Moreover, the contour component γ-curve limiter correction processing section 2007 outputs the contour correction amount (h2) to the gain controller 1005.

FIG. 9 shows the gain controller 1005 combining the CVBS signal (a) with the contour correction amount (h2). The gain controller 1005 combines the CVBS signal (a) with the contour correction amount (h2), and thereby generates a contour correction signal (k2) which has been subjected to contour correction.

Note that the contour correction amount (h2) generated by the contour component γ-curve limiter correction processing section 2007 is not limited to the waveform shown in FIG. 8. FIG. 10 shows processing performed by the contour component γ-curve limiter correction processing section 2007. The contour component γ-curve limiter correction processing section 2007 corrects, in the correction range (g), the contour correction amount (e) generated by the area extracting section 1004 into the contour correction amount (h2), by using a γ-curve limiter for replacing the contour correction amount (e) by a γ-curve different from the γ-curve shown in FIG. 8. FIG. 11 shows the gain controller 1005 combining the CVBS signal (a) with the contour correction amount (h2) shown in FIG. 10. The gain controller 1005 combines the CVBS signal (a) with the contour correction amount (h2), and thereby generates the contour correction signal (k2) different from the waveform shown in FIG. 9.

As described above, the contour correction circuit 2000 according to the second embodiment of the present invention can solve a problem of overshoot caused at an edge of a video screen, perform optimum contour correction without excessive contour correction on a video image border part, and increase the sharpness of the image.

### Third Embodiment

FIG. 12 shows a contour correction circuit 3000 according to a third embodiment of the present invention. The contour correction circuit 3000 includes a contour component average limiter correction processing section 3007 in place of the contour component linear limiter correction processing section 1007 of the contour correction circuit 1000 according to the first embodiment of the present invention. In FIG. 12, the same components as those of the contour correction circuit 1000 shown in FIG. 1 are denoted by the same reference numerals, and the description thereof is omitted.

FIG. 13 shows processing performed by the contour component average limiter correction processing section 3007. A shaded area in FIG. 13 is the correction range (g) determined by the contour component correction range determining section 1006. The contour component average limiter correction processing section 3007 corrects, in the correction range (g), the contour correction amount (e) generated by the area extracting section 1004, by using an average limiter for replacing the contour correction amount (e) by an average of a contour correction component, and thereby generates a contour correction amount (h3). Moreover, the contour component average limiter correction processing section 3007 outputs the contour correction amount (h3) to the gain controller 1005.

FIG. 14 shows the gain controller 1005 combining the CVBS signal (a) with the contour correction amount (h3). The gain controller 1005 combines the CVBS signal (a) with the contour correction amount (h3), and thereby generates a contour correction signal (k3) which has been subjected to contour correction.

As described above, the contour correction circuit 3000 according to the third embodiment of the present invention can solve a problem of overshoot caused at an edge of a video screen, perform optimum contour correction without excessive contour correction on a video image border part, and increase the sharpness of the image.

Note that since each of the contour correction circuits according to the first to third embodiments of the present invention is included in the screen video signal processing section 110 of the television system 100 shown in FIG. 15, a video image displayed on a display apparatus is further sharpened.

Note that typically, function blocks included in each of the contour correction circuits according to the first to third embodiments of the present invention are realized as an LSI (which is referred to as an IC, a system LSI, a super LSI, an ultra LSI, or the like, depending on their integration degree) which is an integrated circuit. Each of the function blocks may be included in one chip, or some or all of the function blocks may be included in one chip.

In addition, a method of forming an integrated circuit is not limited to LSI, and an integrated circuit may be realized by using a dedicated circuit or a general-purpose processor. Alternatively, an FPGA (Field Programmable Gate Array) which can be programmed after an LSI is manufactured, or a reconfigurable processor which enables a connection or setting of a circuit cell in an LSI to be reconfigured, may be used.

Moreover, if a technology, for forming an integrated circuit, which can replace LSI emerges owing to advancement of a semiconductor technology or owing to another technology derived therefrom, it is natural that such a technology may be used for integrating function blocks. There is a possibility that biotechnology is applied, for example.

### INDUSTRIAL APPLICABILITY

A contour correction circuit of the present invention is useful for solving a problem of overshoot and realizing a high-definition image or the like in a video apparatus or the like. In addition, the contour correction circuit of the present invention can solve a problem of overshoot without performing processing of, for example, narrowing the display range on the screen by overscan or the like to hide overshoot, narrowing a contour correction processing area when two screens are displayed, or hiding overshoot by using a black frame. Therefore, the contour correction circuit of the present invention is useful for, for example, effectively using the display range on the screen, and a significant effect can be expected.

1. A contour correction circuit which corrects a contour component of a screen video signal, the contour correction circuit comprising:
a contour component extracting section for extracting the contour component from the screen video signal;
a comparator for comparing an amplitude of the contour component with a threshold value;
a contour correction amount calculation section for, based on a result of the comparison, adjusting the amplitude of the contour component and calculating a contour correction amount;
an area extracting section for extracting, from the contour correction amount, a contour correction amount in a video image area for which a certain contour correction is to be performed;
a contour component correction range determining section for determining, as a correction range of the contour component of the screen video signal, a video image edge area which is an upper, lower, right, or left edge of the video image area;
a contour component linear limiter correction processing section for correcting the contour correction amount extracted by the area extracting section, by performing linear limiter processing which connects, by a straight line, amplitude values of a start point and an end point of the video image edge area which is the upper, lower, right, or left edge and is the correction range; and
a gain controller for combining the screen video signal with a contour correction amount generated by the contour component linear limiter correction processing section.

2. A contour correction circuit which corrects a contour component of a screen video signal, the contour correction circuit comprising:
a contour component extracting section for extracting the contour component from the screen video signal;
a comparator for comparing an amplitude of the contour component with a threshold value;
a contour correction amount calculation section for, based on a result of the comparison, adjusting the amplitude of the contour component and calculating a contour correction amount;
an area extracting section for extracting, from the contour correction amount, a contour correction amount in a video image area for which a certain contour correction is to be performed;
a contour component correction range determining section for determining, as a correction range of the contour component of the screen video signal, a video image edge area which is an upper, lower, right, or left edge of the video image area;
a contour component γ-curve limiter correction processing section for correcting the contour correction amount extracted by the area extracting section, by performing γ-curve limiter processing which connects, by a γ-curve, amplitude values of a start point and an end point of the video image edge area which is the upper, lower, right, or left edge and is the correction range; and
a gain controller for combining the screen video signal with a contour correction amount generated by the contour component γ-curve limiter correction processing section.

3. A contour correction circuit which corrects a contour component of a screen video signal, the contour correction circuit comprising:
a contour component extracting section for extracting the contour component from the screen video signal;
a comparator for comparing an amplitude of the contour component with a threshold value;
a contour correction amount calculation section for, based on a result of the comparison, adjusting the amplitude of the contour component and calculating a contour correction amount;
an area extracting section for extracting, from the contour correction amount, a contour correction amount in a video image area for which a certain contour correction is to be performed;
a contour component correction range determining section for determining, as a correction range of the contour component of the screen video signal, a video image edge area which is an upper, lower, right, or left edge of the video image area;
a contour component average limiter correction processing section for correcting the contour correction amount extracted by the area extracting section, by using an average limiter which averages amplitude values of the video image edge area which is the upper, lower, right, or left edge and is the correction range; and
a gain controller for combining the screen video signal with a contour correction amount generated by the contour component average limiter correction processing section.

4. A broadcast reception apparatus which demodulates a video signal and an audio signal included in a television signal and outputs a video and an audio, the broadcast reception apparatus comprising:
a television signal reception section for receiving the television signal via a broadcast path;
a video signal processing section for demodulating the video signal;
an audio signal processing section for demodulating the audio signal;
an instruction input section for receiving an instruction from an operator; and
an event management section for determining processing to be executed, based on a current state and an input from the instruction input section,
wherein the video signal processing section includes the contour correction circuit according to claim 1.

5. A broadcast reception apparatus which demodulates a video signal and an audio signal included in a television signal and outputs a video and an audio, the broadcast reception apparatus comprising:
a television signal reception section for receiving the television signal via a broadcast path;
a video signal processing section for demodulating the video signal;
an audio signal processing section for demodulating the audio signal;
an instruction input section for receiving an instruction from an operator; and
an event management section for determining processing to be executed, based on a current state and an input from the instruction input section,
wherein the video signal processing section includes the contour correction circuit according to claim 2.

6. A broadcast reception apparatus which demodulates a video signal and an audio signal included in a television signal and outputs a video and an audio, the broadcast reception apparatus comprising:
a television signal reception section for receiving the television signal via a broadcast path;
a video signal processing section for demodulating the video signal;
an audio signal processing section for demodulating the audio signal;
an instruction input section for receiving an instruction from an operator; and
an event management section for determining processing to be executed, based on a current state and an input from the instruction input section,
wherein the video signal processing section includes the contour correction circuit according to claim 3.
